(19) United States
(12) Patent Application Publication
(10) Pub. No.: US 2024/0153356 A1
(43) Pub. Date: May 9, 2024

(54) METHOD FOR PROCESSING DATA IN A DATA PROCESSING SYSTEM

(71) Applicant: Edimon GmbH, Waldkraiburg (DE)

(72) Inventor: Fitim GAJRAKU, Schierling (DE)

(21) Appl. No.: 18/006,296

(22) PCT Filed: Feb. 11, 2022
(86) PCT No.: PCT/EP2022/053371

§ 371 Date: Jan. 20, 2023

(51) Int. Cl. G07F 17/32

(52) U.S. Cl. CPC G07F 17/3288; G07F 17/3239; G07F 17/3244; G07F 17/3267

(57) ABSTRACT

The invention relates to a method for processing data in a server-based data processing system (10), which data processing system (10) handles a plurality of scheduled events (22, 24) as well as bets on the outcome of said events, in which processing data system (10) the bets can be input into the data processing system (10) via data input devices (16, 20), in which data processing system (10) credits are given if entered bets match the outcome of the related events,

wherein the data processing system (10) offers a combined bet for at least two events, which combined bet links said events in a manner that a player is credited only if his bets regarding a specified portion of said events of the combined bet are correct.

According to the invention the data processing system provides for said combined bet an amendment routine, which keeps a player's combined bet valid even if his bets regarding the outcome of a specified portion of any of said events of the combined bet except the last event are incorrect.

### BACKGROUND OF THE INVENTION

The present invention refers to a method for processing data in a server-based data processing system, in which the data processing system handles a plurality of scheduled events as well as bets on the outcome of these events. The bets can be input usually during an access time period prior to the event's outcome into the data processing system. If a bet entered by a player matches the outcome of the event, credits are given by the data processing system to the player. Such data processing systems are regularly online bet systems which allow, a user or player, the placing of a guess for scheduled events as e.g. sport matches but also card games, etc.

The inventive data processing system further offers a combined bet for at least two events, e.g. two sports events, the combined bet links at least two events in a manner that a participant is credited only if his bets regarding a specified portion of the at least two events of the combined bet is correct, otherwise the combined bet is forfeited. Accordingly, e.g. the bet is won if the participant's guess matches with at least one partial aspect of each of the at least two events, e.g. won/lost etc. Of course, the bet can also relate to the exact outcome. e.g. in soccer matches, if the exact outcome corresponds to the number of goals or goal difference.

Although, combined bets offer a new type of extended bet options, this combining of several events has the disadvantage that if a bet on only one outcome of the combined events is wrong, the whole combined bet is forfeited. Particularly, if a combined bet links more than two events, e.g. four or five events, the probability that one of the outcomes of the events is guessed wrong is quite high, which might generally affect the acceptance of combined bets with the participants or players.

### SUMMARY OF THE INVENTION

It is an object of the present invention to provide a method and a data processing system which offers a better acceptance for combined bets with the players.

The inventive method offers to a player of a combined bet, an amendment routine, which keeps his guess or bet valid if it is incorrect regarding the outcome of at least a specified portion of the events.

With this amendment routine, which is designated hereinafter as “Wildcard”, the player can still continue his combined bet with respect to the other one(s) of the combined events, so that after a wrong guess on one of the events, his complete combined bet is not forfeited. This makes the playing of a combined bet more promising and interesting.

The amendment routine or “Wildcard” has to be taken by a player prior to the outcome of any of the combined events which does not match the player's bet, except the last event. If, e.g., the combined bet comprises four events and the player's bets on the first two events were correct, he might “draw the wildcard” until the outcome of the next event. So he can, e.g., during the course of the third event verify based on its intermediate status, whether or not his bet might be wrong. Thus, with the amendment routine, he can save his correct bets for the first two events of his combined bet, even if his guess for the third event should fail.

In a preferred embodiment of the invention, the crediting amount for the player taking the amendment routine is changed during the course of the event. Thus, if the access time period for a guess ends after the start of an event, e.g. prior to the event's outcome, the intermediate status of an event surely affects the player's guess. Accordingly, this knowledge of the intermediate status of an event could be considered by changing, e.g. lowering the amount to be credited in case of a correct guess.

Generally, bets are credited according to quotes which reflect the probability for a certain outcome of an event. In order to extend the access time period for the entry of a guess, the guess might also be entered after the start of the event. Preferably, in this case, the crediting quote for the player taking the amendment routine is decreased over the run time of at least one event of the combined bet.

Advantageously, the amendment routine is offered to a player in the data processing system for all events of the combined bet except the last one, as currently there are also options to terminate a combined bet before the last event has an outcome. Thus, if a combined bet comprises three events, the wildcard can be drawn for the first two events of the combined bet.

Preferably, after taking the amendment routine, the quote for the miss-guessed event is set to a value between 0 and 1, so that the guess of the player of the combined bet is still valid.

In case, a player takes the amendment routine for his combined bet, the credits for the remaining event(s) of the combined bet are lowered as a kind of compensation for saving the bet. Accordingly, the quote for the lost event/game can be reduced and thus the gain can be minimized.

In a preferred embodiment of the invention, the data processing system handles member-accounts, comprising at least the participant's ID (identification) data and his current guess data, preferably also his bank account data. Via this measure, the input of bets and the crediting can easily be accomplished via the player's member accounts.

Preferably, the member account comprises guess history data and that the amendment routine is offered to the participant dependent on the history of his bets. Accordingly, advertising and crediting of bonuses, e.g. offering of free bets or free amendment routines can be handled based on his guess history in his member account.

The accessibility to the data processing system is greatly enhanced if the communication between the participant and the data processing system is via an App installed on a client terminal device, preferably on a mobile device. Accordingly, the player can always participate in bets and can be informed in time about the status of the relevant events and about the status of his bets.

The invention also refers to a server-based data processing system, comprising:
an event data memory, configured to store at least event ID (identification) data, with start time, end time and at least outcome of the event,
data input devices for players for the entry of guess data to bets on the outcome of an event from the event data memory, preferably client terminal devices as smartphones, but also game consoles in game halls, and
a bet processing unit for handling the guess data entries for all bets and comprising a comparator to compares the outcome and optionally also current status of an event with the entered guess data, wherein the bet processing unit comprises a crediting unit for the players according to the comparison result of the bet processing unit.

The data processing system offers a combined bet for at least two events from the event data memory, for which combined bet, the bet processing unit is configured to link the events of the combined bet in a way that the member account is credited only if his guess regarding a specified portion of the events of the combined bet is correct. This combined bet enhances the play options for a player participating in a bet system and probably makes it more interesting.

According to the invention, the bet processing unit comprises an amendment routine, which keeps a combined bet valid even if the entered guess data are incorrect regarding the outcome of a specified portion of the events of the combined bet.

This makes the use of a combined bet more appealing. The “saving” of his combined bet via the amendment routine or wildcard can be compensated, e.g., by lowering the credit quotes for the remaining events. This amendment routine preferably must be taken by a player, but it can also be given to a player as a bonus, which he doesn't have to activate.

Preferably, the data input device is a software interface in client terminal devices, which is easy to realize and to customize to specific bet systems.

Following terms are used as synonyms: user—player—participant—member account holder; amendment routine—wildcard; combi bet—combined bet; input device—client terminal device—mobile device; combi—combined; guess—tip—bet.

### BRIEF DESCRIPTION OF THE DRAWINGS

The invention is now described hereinafter by the aid of an embodiment in connection with the enclosed drawings.

FIG. 1 shows a data processing system for handling single and combined bets;

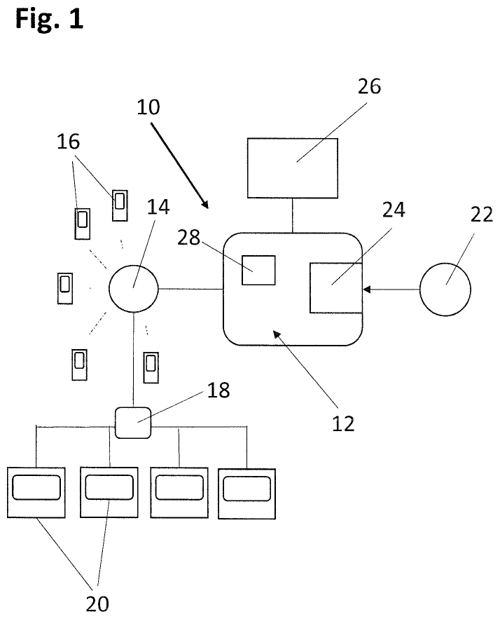

FIG. 2 shows a flow-chart for entering a bet;

FIG. 3 shows a flow-chart for the data entry for a combined bet;

FIG. 4 shows a flow-chart of the data processing of a combined bet; and

FIG. 5 shows a wildcard option routine for enabling an amendment routine in a player's combined bet.

### DETAILED DESCRIPTION OF THE INVENTION

The data processing system 10 comprises a server 12 which is connected to a public communication network 14 as, e.g. the Internet. A plurality of individual terminal devices 16, for example smartphones, as well as game halls 18 comprising a plurality of game consoles 20 are connected to the server 12 via the communication network 14. The server 12 is connected with an event data source 22 for scheduled events, e.g. soccer matches or card games or gambling events. From the event data source 22, the type of an event, its starting time, its scheduled end time, as well as the intermediate status and final outcome of the event are forwarded to an event memory 24 of the server 12.

Preferably, the server 12 has a member account memory 26 in which the members' IDs (identifications), the member's bet history, current bets, debiting and crediting data and eventually bonuses etc. are stored. The server 12 has a bet processing unit 28 which processes all entered bets which are inputted by players via their terminal devices 16 or game consoles 20. The bet processing unit 28 handles the intermediate status and final outcomes of events from the event memory 24 and the entered bets with the estimated outcomes of the events. Finally, the bet processing unit 28 credits and debits amounts corresponding to the active bets of the players. Hereby, it is to be considered that the participation via terminal devices 16 regularly necessitates some kind of player ID which can be stored in the member account memory 26, whereas playing on game consoles 20 in game halls 18 enables an anonymous participation on the bets handled the data processing system 10, whereby in this case preferably, the debiting and crediting is performed directly via the game hall 18.

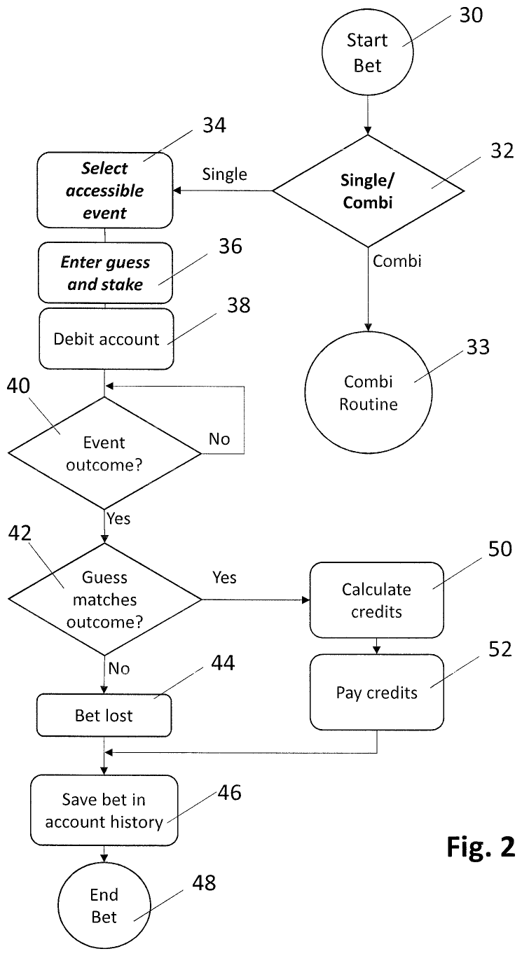

FIG. 2 shows a flow-chart of a bet performed by a player, whereby his own terminal device 16 or a game console 20 of a game hall 18 acts as an I/O (input/output) device for the data processing system 10 run on the server 12.

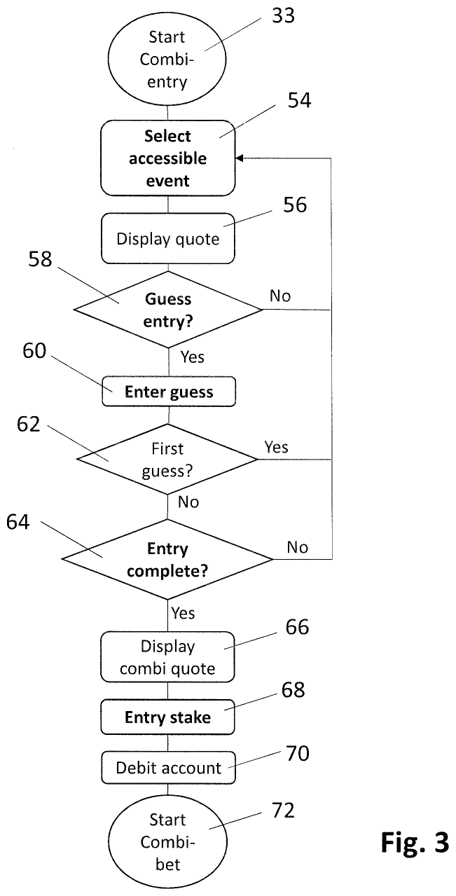

At the start step 30, the processing of his bet starts and proceeds to the single/combi selection step 32 in which the player has to decide whether he wants to perform a single bet or a combined bet. In case he wants to play a combined bet, he is led to the combi routine 33 which is further carried out in FIG. 3.

In case he wants to play a single bet, the flow-chart branches to the event input step 34 where the player has to select an accessible event from the available events. The term “accessible event” in this connection means that the event is already present in the event memory 24 but which has not yet started or at least has not yet ended so that its outcome is still open, so that the access time period for entering bets for that event is open. After having selected an event in the event input step 34, the player is led to the guess and stake input step 36 where the player has to enter his guess, e.g. win/lose or goal ratio or a number or color in roulette etc., as well as the stake for his guess. The guess for a sport event may involve for example simply a decision whether or not one of two teams win or lose, or in an extended guess even a goal ratio, for example in soccer or other ball games. In card games, the bets can go on card colors or card values etc. Aside of his guess, the player also has to enter in the guess and stake input step 36 his stake, i.e. what amounts he wants to place on his guess. After having input these required data, his account is debited in the next accounting step 38.

The data processing system 10, particularly the bet processing unit 28, continuously monitors the event in question with the outcome monitoring step 40 on its outcome. After the event's outcome, the procedure proceeds to the comparison step 42 in which the comparator of the bet processing unit 28 internally checks whether the player's guess matches the event's outcome. If this is not the case, the flow-chart proceeds to the bet lost step 44 wherein the player is informed that he lost the bet, and maybe also showing the outcome of the event and his guess and if the player has a member account the bet is saved in his account history in the bet history saving step 46 whereafter the bet procedure ends in the terminal step 48.

If the bet processing unit 28 finds in the comparison step 42 that the player's guess matches the outcome of the event, the flow-chart branches to the credit calculating step 50 in which the bet processing unit 28 calculates the credits to be paid to the player based on the quote that is set by the company running the data processing system 10, regularly based on statistical data of all player bets on the event outcomes. After having calculated the credits, the flow-chart proceeds to the credit step 52 wherein the credit is paid either to the member account in the member account memory 26 or, if the player is playing on a game console 20 in a game hall 18, the credits are directly paid to the player via a person or machine in the game hall 18. If the player is registered, the bet is according to bet history saving step 46 stored in his account history of his member account in the member account memory 26 and the bet handling proceeds to the terminal step 48.

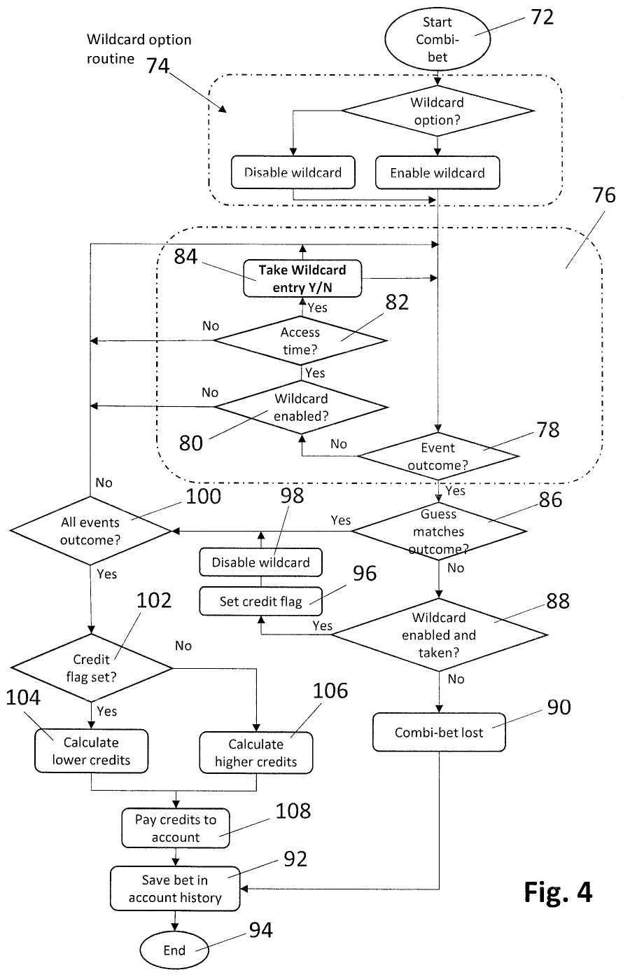

FIG. 3 shows the further handling if the player chose in the single/combi selection step 32 of FIG. 2 to play a combined bet. The combined bet starts in the start field of the combined bet data entry 33 and proceeds to the event selection step 54 where the player has to select one of the accessible events from the event memory 24 of the server 12. With his selection, the crediting quote for the event is shown to him in the display step 56. In the confirmation/rejection step of the event selection 58, the player can choose whether or not he wants to place a guess on the chosen event. If not, he is branched back to the event selection step 54. If the player wants to enter a guess for the selected event, he is forwarded to the guess entry step 60 where he enters his guess. From there, the flow-chart proceeds to the guess number check 62 where the bet processing unit 28 checks whether this was the first guess of the combi-bet in which case it branches back to the event selection step 54 to input at least a second event for the combined bet. If it is not the first guess, this means that the player has at least inputted bets for two different events. Thus, now he is asked in the guess entry confirmation step 64 for the combined bet whether all entries for the combined bet have been made. If he wants to add further events, he is branched back to the event selection step 54. If a combined bet has a fixed number of combined events the re-branching to the event selection step 54 is repeated automatically until he has input the set number of events. If his entry for the combined bet is completed, his combi quote is displayed in the combi quote display step 66 whereafter the player has to enter in the stake entry step 68, his stake for the combined bet. After the entry of his stake, his account will be debited in the debiting step 70 and the entry of the combined bet is ended in the start field 72 for the processing of the combined bet according to FIG. 4.

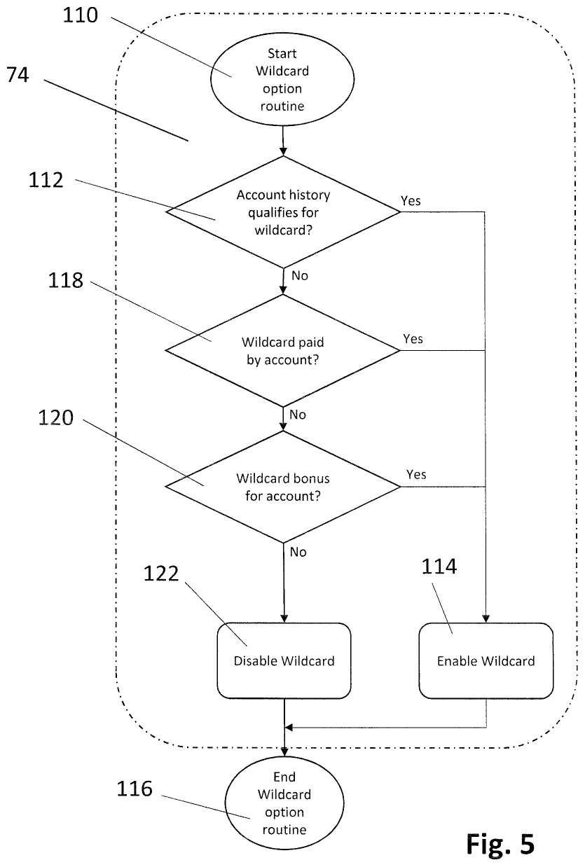

According to FIG. 4 the processing of the combined bet starts in processing the start field 72 with the end of the entry of the events and bets for his combined bet according to FIG. 3. From this start field 72, it is proceeded to a Wildcard option routine 74 which is shown in detail in FIG. 5. With this Wildcard option routine 74, it is checked whether a Wildcard is available for the player for his combined bet. The Wildcard defines an amendment routine which keeps the player's combined bet valid even if one of his bets of the combined bet is wrong. Thus, after having determined whether or not a wildcard is enabled or not, the combined bet proceeds to the event monitoring procedure 76 in which the events of the combined bet are monitored on their outcomes via the outcome checking step 78, i.e. in this step it is checked whether the events have already an outcome, i.e. a final result. If no event outcome is present, it is proceeded to the wildcard checking step 80 of the bet processing unit 28 in which it is checked whether the Wildcard is enabled for the player in the above-mentioned Wildcard option routine 74 or not. If this is not the case, it is proceeded back to the outcome checking step 78. If the Wildcard is enabled, it is internally checked in the access time checking step 82 whether the access time for taking a Wildcard is open. If this is not the case, it is branched to the outcome checking step 78. If the access time is identical with the time prior to the event result, this step can be omitted. If a Wildcard for the combined bet can still be taken, it is proceeded to the wildcard entry step 84 which offers the drawing of a Wildcard to the player, which he can take or not. From there, it is proceeded back to the outcome checking step 78. If during this event monitoring of the outcome checking step 78, it is found that an event has an outcome, it is proceeded to the comparison step 86 where it is checked in the comparator of the bet processing unit 28 whether the player's guess matches the event outcome.

If the player's guess is found wrong in the comparison step 86, it is proceeded to the wildcard checking step 88 where it is checked whether the player has taken the Wildcard in the wildcard entry step 84. If he didn't, it is proceeded to the combi-bet lost step 90 where the player is informed, e.g. via the display of the terminal device 16 that the combi-bet is forfeited. From there, it is proceeded to the history saving step 92 where the bet is saved in the account history of the member account if the player is owner of a member account, and from there, the combi bet procedure proceeds to the end field 94. If however it reveals in the decision step 88 that the Wildcard has indeed been taken by the player, a credit flag is set in the step 96 after which the Wildcard is disabled in the disabling step 98. Via this disabling of the Wildcard in the disabling step 98, it is ensured that the player can place the Wildcard only once, i.e. only for one event of the combined bet.

If the player's guess is found correct in the comparison step 86 it is proceeded to the decision step 100, where it is checked whether all events have already an outcome or not. If this is not the case, the combined bet routine branches back to the event monitoring procedure 76.

Finally, if the event outcomes of all events of the combined bet are present, it is branched to the credit flag checking step 102 where it is checked whether the credit flag is set. The credit flag has been set in the step 96 in a case where the Wildcard has been taken to amend a wrong guess. Thus, if the credit flag is set, it is proceeded to the calculation step 104 where lower credits are calculated to be paid to the player's member account. If the credit flag is not set, the credit flag checking step 102 branches to the calculation step 106 where a higher credit amount is calculated, usually depending on the combi quote of the combined bet and the player's stake. Both calculation steps 104 and 106 proceed to the crediting step 108 to pay the win to the member account. From there it is proceeded to the bet history saving step 92 of combi bet in which the combi bet is stored in the account history, if the player has a member account. After this step the combi bet ends in the end field 94.

Finally, an optional Wildcard option routine 74 is described in FIG. 5. The Wildcard option routine starts in the Wildcard routine start field 110 and proceeds to a first Wildcard checking field 112 where it is checked whether the account history of the player's member account qualifies the member account for a Wildcard. This is, for example, preferable if the player is a frequent player and places a lot of bets so that such a Wildcard can be granted as a bonus if the player is a long and/or frequent player. So if the account history qualifies for the Wildcard, the procedure proceeds to the enabling Wildcard step 114 enabling the Wildcard for the player and from there it proceeds to the end step 116 from which the Wildcard option routine 74 goes to the monitoring procedure 76 of the combined bet routine of FIG. 4.

If the account history in the wild card checking field 112 does not qualify for a Wildcard, it is proceeded to the decision field 118 where it is checked whether or not the player has paid for a Wildcard. If this is the case, the routine again branches to the enabling Wildcard step 114 and from there to the end step 116. If the player has not paid for a Wildcard, it is proceeded to the decision field 120 where it is checked whether some special bonus exists for the player's account, for example the gaining of a Wildcard in a kind of lottery or some special events held by the company running the data processing system 10. If such a bonus is present for the player's account, it is again branched to the enabling field 114 and from there to the end step 116. If also no bonus is available for the player's account, it is branched to the disabling field 122 and from there to the end step of the Wildcard routine so that the following combined bet procedure of FIG. 4 is running without giving the player the option to take a Wildcard in the combined bet.

A Wildcard can furthermore be awarded to a player dependent on his minimum stake and/or dependent on minimum quotes of the single bets of his combi bet.

The above system and procedure only specified one embodiment of the invention which can be varied within the scope of the appended patent claims.

### LIST OF REFERENCE NUMBERS

10 data processing system—server based online bet platform
12 data server
14 public communication network—Internet
16 client terminal devices—mobile devices—smartphones with I/O App or browser based I/O
18 game halls
20 game consoles in game halls
22 event data source
24 event memory
26 member account memory
28 bet processing unit
30 start step of bet processing
32 single/combi selection step to choose between single bet and combined bet
33 start field of combined bet data entry
34 event input filed in single bet routine
36 guess and stake input filed in single bet routine
38 accounting step—preferably debiting member account in member account memory
40 outcome monitoring step
42 comparison step—correct/incorrect guess
44 bet lost display step
46 bet history saving step of single bet
48 end step of single bet
50 credit calculating step of single bet
52 crediting step of single bet
54 event selection step of combi bet
56 bet quote display step
58 confirmation/rejection step of event selection
60 guess entry step for combined bet
62 guess number check
64 guess entry confirmation step for combined bet
66 combi quote display step
68 stake entry step for combined bet
70 debiting step, preferably on member account
72 start field of combi bet routine
74 wildcard option routine
76 event monitoring procedure of combined bet
78 event outcome checking step
80 wildcard enabled
checking step
82 access time checking
step
84 entry step for drawing wildcard
86 comparison step correct/wrong guess for combi bet
88 wildcard checking step
90 display step for lost bet
92 bet history saving step of combi bet
94 end field of combi bet routine
96 set credit flag step
98 disable wildcard step
100 outcome checking step—all events of combined bet have an outcome?
102 credit flag checking step
104 credit calculation step—lower credit
106 credit calculation step—higher credit
108 credit step—pay credit to player or to member account
110 start field of wildcard option routine
112 first wildcard checking field—account history
114 enable wildcard step
116 end field of wildcard option routine
118 second wildcard checking field—wildcard paid
120 third wildcard checking field—bonus option
122 disable wildcard step

1. A method for processing data in a server-based data processing system, comprising the steps of:
handling a plurality of scheduled events and a plurality of bets on an outcome of the plurality of scheduled events, in which the plurality of bets is input into a server-based data processing system via data input devices;
issuing credits if the plurality of bets match the outcome of the plurality of scheduled events, wherein the server-based data processing system offers a combined bet option for at least two events of the plurality of scheduled events, where the combined bet option links the plurality of scheduled events in a manner that a player is credited only if a player's bets regarding a specified portion of the plurality of scheduled events of the combined bet option are correct; and
running an amendment routine in combination with the combined bet option, the amendment routine keeps a player's combined bet valid even if the player's bets are incorrect regarding an outcome of a specified portion of any of the plurality of scheduled events of the combined bet except a last event is incorrect.

2. The method according to claim 1, in which a crediting amount for the player taking the combined bet option in the amendment routine is changed during a course of the event.

3. The method according to claim 2, wherein the player's bets are credited according to quotes which reflect a probability for a certain outcome of an event, and that a crediting quote for the player taking the amendment routine is decreased over a run time of an at least one event of the combined bet option.

4. The method according to claim 1, wherein a bet to an outcome of an event can be input during an access time period prior to the outcome of the event.

5. The method according to claim 4, wherein the amendment routine can be taken by a player during the access time period.

6. The method according to claim 4, wherein the access time period ends with a beginning of at least one of the combined events.

7. The method according to one of claim 4, wherein the access time period ends with the outcome of one of the combined events, whereby quotes are continuously reduced during the event.

8. The method according to claim 1, wherein after taking the combined bet option in the amendment routine a quote for a miss-guessed event is set to a value between 0 and 1.

9. The method according to according to claim 1, wherein the credits for remaining events of the combined bet option are lowered.

10. The method according to according to claim 1, wherein the server-based data processing system handles member accounts, comprising at least a participant's ID data and current guess data.

11. The method according to claim 10, wherein the member accounts comprise guess history data and an indication that the combined bet option of the amendment routine is offered to the player dependent on a history of the player's bets.

12. The method according to according to claim 1, wherein communication between the player and the server-based data processing system is via an App installed on a terminal device or on a mobile device.

13. A server-based data processing system, comprising:
an event data memory comprising at least event ID data, with a start time, an end time, and at least an outcome of an event,
data input devices for players for entry of guess data to bets on the outcome of the event from the event data memory, and
a bet processing unit, which handles all of guess data entries to all of the bets, and the bet processing unit comprises a comparator unit which compares the outcome of the event and a current status of an event with the guess data entries,
the bet processing unit further comprises a crediting unit for the players according to a comparison result of the bet processing unit, the server-based data processing system offers a combined bet option for at least two events of an event data memory, the bet processing unit is configured to link the events of the combined bet option in a way that a member account is credited only if a guess regarding a specified portion of the event of the combined bet option is correct, otherwise a guess for the combined bet option is deemed forfeited, wherein the bet processing unit comprises an amendment routine for the combined bet option, which keeps a combined bet valid even if entered guess data are incorrect regarding the outcome of a specified portion of the event of the combined bet except the last bet.

14. The server-based data processing system according to claim 13, wherein the data input devices are a software interface running in client terminal devices.
